(19) United States
(12) Patent Application Publication
(10) Pub. No.: US 2008/0206708 A1
(43) Pub. Date: Aug. 28, 2008

(54) Dental Prosthesis and Its Manufacturing Method

(76) Inventor: Oh-Dal Kwon, Daegu (KR)

Correspondence Address: H.C. PARK & ASSOCIATES, PLC, 8500 LEESBURG PIKE, SUITE 7500, VIENNA, VA, 22182, US

(21) Appl. No.: 11/915,123

(22) PCT Filed: Feb. 10, 2006
(86) PCT No.: PCT/KR2006/000477

§ 371 Date: Nov. 20, 2007

(30) Foreign Application Priority Data
Jun. 10, 2005 (KR) 10-2005-0049604
Jul. 5, 2005 (KR) 10-2005-0059983
Jul. 12, 2005 (KR) 10-2005-0062693
Dec. 14, 2005 (KR) 10-2005-0122872
Jan. 6, 2006 (KR) 10-2006-0001540

(51) Int. Cl. A61C 13/225

(52) U.S. Cl. 433/172

(57) ABSTRACT

Disclosed herein are a dental prosthesis and its manufacturing method for restoring a lost tooth. The dental prosthesis has a male member formed on a holding part attached on an adjacent tooth for attaching an artificial tooth on the adjacent tooth and a female member formed in the artificial tooth so that the artificial tooth and the adjacent tooth can be connected with each other without grinding the adjacent tooth. The method for manufacturing the dental prosthesis includes the steps of duplicating an original model, waxing up the duplicated model, holding a sprue on the duplicated model in a state where the duplicated model is waxed up, and investing, burning out and casting the duplicating model.

### TECHNICAL FIELD

The present invention relates to a dental prosthesis and its manufacturing method for restoring lost tooth, and more particularly, to a dental prosthesis which has a male member formed on a holding part attached on an adjacent tooth for attaching an artificial tooth on the adjacent tooth and a female member formed in the artificial tooth so that the artificial tooth and the adjacent tooth can be connected with each other without grinding of the adjacent tooth, and a method for manufacturing the dental prosthesis which includes the steps of duplicating an original model, waxing up the duplicated model, holding a sprue on the duplicated model in a state where the duplicated model is waxed up, and investing, burning out and casting the duplicated model.

### BACKGROUND ART

In general, to restore a lost tooth, an adjacent tooth located by the side of an artificial tooth to be restored is ground, and a crown made of metal or ceramic material is covered on the ground adjacent tooth and connected and fixed to the artificial tooth.

For a representative example of the conventionally dental prosthesis, there is a crown bridge. In the case of the conventional crown bridge, adjacent teeth 1 located at both sides of an artificial tooth to be restored are ground from the dotted line to the solid line shown in FIG. 1, and the artificial tooth 2 shown in FIG. 2 is connected to a crown 2a formed on an abutment and fixed at the ground portion.

However, the conventional crown bridge has several disadvantages in that it causes degeneration or exposure of dental pulp, or hypersensitivity since a loss of tooth substance is increased, and in that it is impossible to restore the original occlusal form due to the grinding of the occlusal surface of the adjacent teeth. Moreover, occasionally, it is necessary to previously carry out endodontic treatment since an amount of tooth grinding is increased during restoration of a severely inclined tooth.

Alternatively, there is an implant as the dental prosthesis. The implant prosthesis is a method for fixing an artificial tooth using a screw after implanting a metal artificial root. However, the implant has several disadvantages in that it takes much time and money to fix the artificial tooth, has limitations in restoration in the case of patients of severe periodontal disease, wasting diseases, diabetes and hematologic diseases, and is relatively weak to lateral pressure.

Therefore, development of a dental prosthesis which is easy to operate and can fix the artificial tooth without grinding of adjacent teeth has been required. In the prior art prostheses, it is difficult to apply various prostheses according to conditions of adjacent teeth, since it is unavoidable to form holes in the adjacent teeth or grind the adjacent teeth to hold the fixed state of the prostheses.

Meanwhile, a method for manufacturing the conventional dental prosthesis includes the steps of waxing up an original model of the prosthesis, removing the waxed-up model from the original model, investing and casting the waxed-up model after holding a sprue on the waxed-up model, and mounting it to the original model.

However, such conventional method has a disadvantage in that it is difficult to obtain holding force to the maximum.

### DISCLOSURE OF INVENTION

### Technical Solution

Accordingly, it is an object of the present invention to provide a dental prosthesis and its manufacturing method, which can fix a holding part to an adjacent tooth with no or little grinding of the adjacent tooth, thereby easily and firmly fixing an artificial tooth to the holding part attached on the adjacent tooth and providing natural and various outward appearances according to tooth conditions.

To achieve the above object, the present invention provides a dental prosthesis which has a male member formed on a holding part attached on an adjacent tooth for attaching an artificial tooth on the adjacent tooth and a female member formed in the artificial tooth so that the artificial tooth and the adjacent tooth can be connected with each other without grinding of the adjacent tooth, and a method for manufacturing the dental prosthesis which includes the steps of duplicating an original model, waxing up the duplicated model, holding a sprue on the duplicated model in a state where the duplicated model is waxed up, and investing), burning out and casting the duplicated model.

### ADVANTAGEOUS EFFECTS

The present invention which has no anesthesia and grinding of teeth can promote dental health since a patient can go to a dental clinic in a good feeling without fear to dental care losing no time of restoration, and restore teeth even in the case of patients, who have hypertension or angina pectoris patient or are warned to anesthesia, restricted in restorations.

The dental prosthesis according to the present invention does not cause over-sensitive reaction and require endodontic treatment after the tooth restoration since it restores the tooth with no grinding of the tooth and no influence on the dental pulp, and can prevent decay of teeth since it conserves enamel, which is the hardest in a human body. Furthermore, the dental prosthesis according to the present invention can keep the present occlusion state since the occlusal surface is not ground, and does not provide the patient with a sense of foreign substance since the opposite tooth is not changed and the contact point with the opposite tooth is kept as it is. In addition, the dental prosthesis does not cause a damage of soft tissue, which may be caused during grinding of the tooth, and prevents decay of teeth by melting of cement due to improper grinding of the tooth.

Moreover, the dental prosthesis according to the present invention can remarkably reduce medical accidents since there is no cross infection between patients due to improper disinfection in a dental clinic, does not need anesthesia agent and tooth grinding agent, remarkably reduces medical consultation hours, and can be easily removed when the dental prosthesis has to be unavoidably removed. Therefore, the dental prosthesis according to the present invention is the most human-friendly.

### BRIEF DESCRIPTION OF THE DRAWINGS

FIG. 1 is a side view showing a grinding portion in the case where a conventional dental prosthesis is applied;

FIG. 2 is a side view showing a mounted state of the conventional dental prosthesis;

FIG. 3 is an exploded perspective view of a dental prosthesis according to the present invention;

FIG. 4 is an enlarged view of a lingual side of FIG. 3;

FIG. 5 is an enlarged view of a lingual side of male members formed at both ends of a holding part of the dental prosthesis according to the present invention;

FIG. 6 is a perspective view and a plan view showing a state where an S-shaped holding part is mounted on adjacent teeth according to the present invention;

FIG. 7 is a perspective view of an integrated type holding part of the present invention;

FIG. 8 is a perspective view of a separated type holding part of the present invention;

FIG. 9 is a perspective view showing a coupling part formed at the rear part of the holding parting FIG. 8;

FIG. 10 is a perspective view showing coverage of the pit, the non-functional cusp and a portion of the occlusal surface;

FIG. 11 is a perspective view of a modification of the holding part of FIG. 7;

FIG. 12 is a plan view of the separated type holding part and the male member of FIG. 8;

FIG. 13 is a plan view of the integrated type holding part and the male member;

FIG. 14 is a side view of the holding parts of FIGS. 7 and 8 seen from the buccal side;

FIG. 15 is a side sectional view, in a partial section, showing a mounted state of the dental prosthesis according to the present invention;

FIG. 16 is a front view, in a partial section, showing an angle of the male member of the dental prosthesis according to the present invention;

FIG. 17 is a sectional view showing a state where the male member of the holding part is coupled to an artificial tooth of the dental prosthesis according to the present invention;

FIG. 18 is a side view showing a mounted state of the prosthesis according to the present invention;

FIG. 19 is a perspective view of an embedded type holding part according to the present invention;

FIG. 20 is a perspective view of the embedded type holding part according to the present invention;

FIG. 21 is a perspective view of the embedded type holding part according to the present invention;

FIG. 22 is a perspective view of the embedded type holding part according to the present invention;

FIG. 23 is a perspective view showing a state where an embedded part is added to FIG. 19;

FIG. 24 is a perspective view showing a modification of the holding part of FIG. 19;

FIG. 25 is a front view and a perspective view showing an indented portion of a scratch type;

FIG. 26 is a front view and a perspective view showing an indented portion of a dot type;

FIG. 27 is a front view and a perspective view showing an indented portion of a hole type;

FIG. 28 is a front view and a perspective view showing an indented portion of a box type;

FIG. 29 is a front view showing a grinding portion on a lingual side of the anterior tooth;

FIG. 30 is a front view showing another grinding portion on the lingual side of the anterior tooth;

FIG. 31 is a perspective view showing the embedment at the rear of an embedded type holding part;

FIG. 32 is a perspective view showing another embedment at the rear of the embedded type holding part;

FIG. 33 is a plan view of the embedded type holding part and a male member;

FIG. 34 is a side view of the holding parts seen from the buccal side;

FIG. 35 is a side sectional view, in a partial section, showing a mounted state of the dental prosthesis according to the present invention;

FIG. 36 is a front view, in a partial section, showing an angle of the male member of the dental prosthesis according to the present invention; and

FIG. 37 is a sectional view showing a state where the male member of the holding part is coupled to an artificial tooth of the dental prosthesis according to the present invention

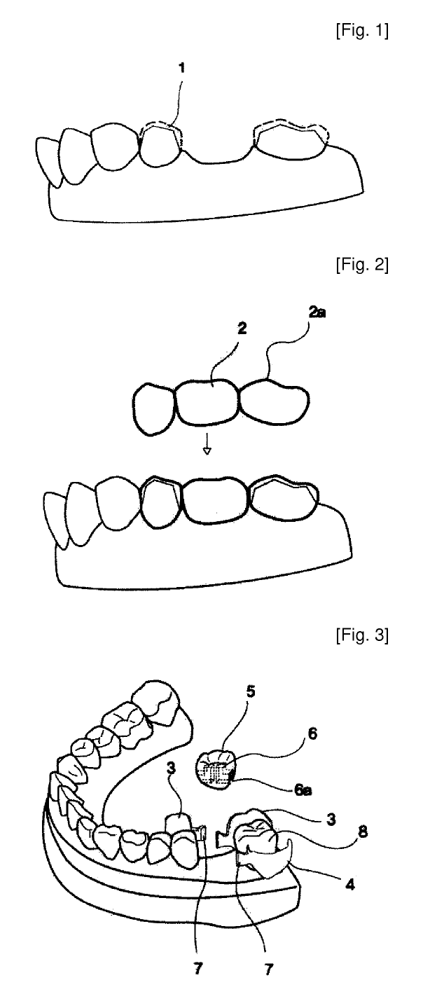

### BEST MODE FOR CARRYING OUT THE INVENTION

Reference will now be made in detail to the preferred embodiments of the present invention, examples of which are illustrated in the accompanying drawings.

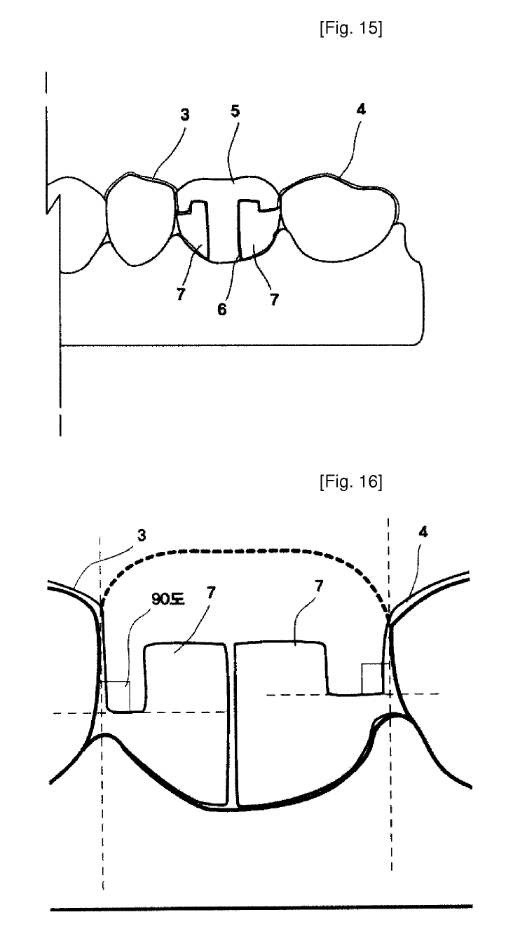

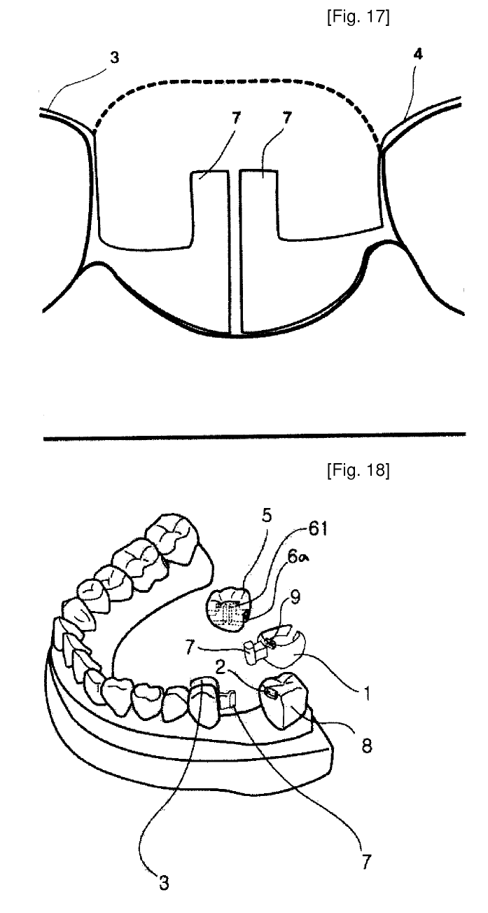

FIGS. 3 to 17 are views showing a dental prosthesis according to a preferred embodiment of the present invention.

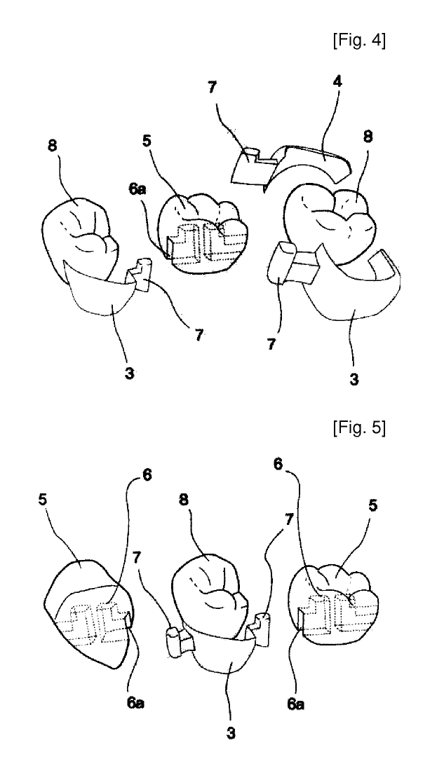

As shown in FIGS. 3 and 4, the dental prosthesis according to the present invention includes: an artificial tooth 5 having female members 6 and slots 6a; and holding parts 3 and 4 respectively having male members 7 formed integrally with the holding parts 3 and 4 and inserted into the female members 6 and the slots 6a of the artificial tooth 5, and fixed to an adjacent tooth 8.

Combining force between the holding parts 3 and 4 and the adjacent tooth 8 is increased by maximizing an area of the holding parts 3 and 4, and combining force between the holding parts 3 and 4 and the artificial tooth 5 is increased by maximizing an area of the female member 6 and the male member 7. At this time, sizes of the female member 6 and the male member 7 are adjustable according to circumstances.

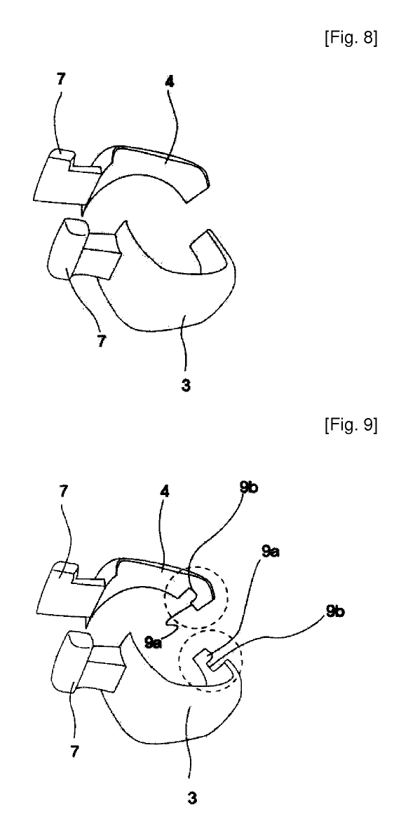

Meanwhile, the male member 7 and the holding parts 3 and 4 are formed integrally with each other as shown in FIG. 7, or divided into a lingual side and a buccal side as shown in FIG. 8.

Furthermore, in the case where the male member 7 and the holding parts 3 and 4 are divided into the lingual side and the buccal side and there is no tooth at the back of the holding parts 3 and 4, as shown in FIG. 9, a pair of projection 9a and groove 9b are formed at the ends of the lingual holding part 3 and the buccal holding part 4 and coupled with each other in order to increase combining force between the holding parts 3 and 4.

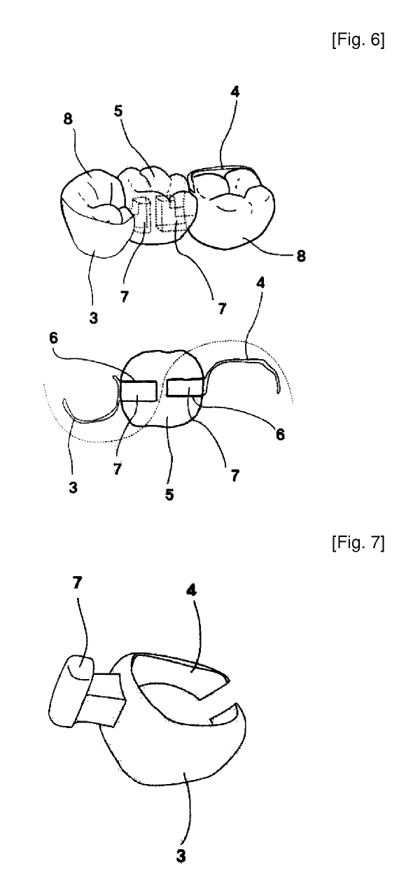

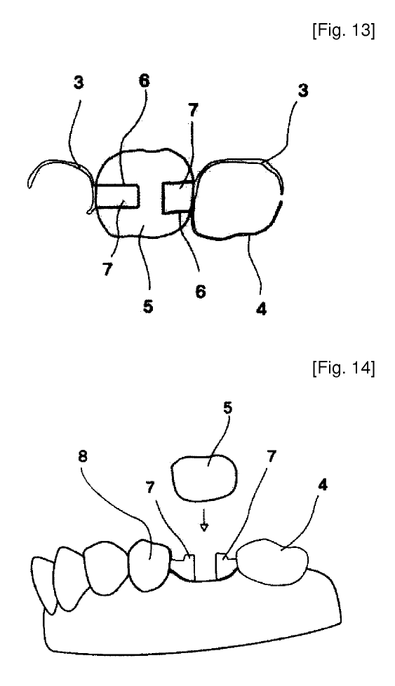

After that, in case of the adjacent tooth 8 whose holding parts 3 and 4 may be exposed to the outside, as shown in FIGS. 12 and 13(3), on the anterior tooth and a portion which requires an aesthetic sense, only the lingual holding part 3 is formed, but on the posterior tooth as shown in FIG. 4, the lingual holding part 3 and the buccal holding part 4 may be formed separately as shown in FIG. 8 or integrally as shown in FIG. 7. Alternatively, the prosthesis can be formed in an S shape (FIG. 6) in such a way that only the lingual holding part 3 is mounted on the anterior tooth and the front portion of the artificial tooth and only the buccal holding part 4 is mounted on a molar tooth and the posterior tooth of the artificial tooth. In the prosthesis having the above structure, the holding part is not exposed to the outside since only the lingual holding part 3 is mounted on the anterior tooth and the portion, which requires the aesthetic sense.

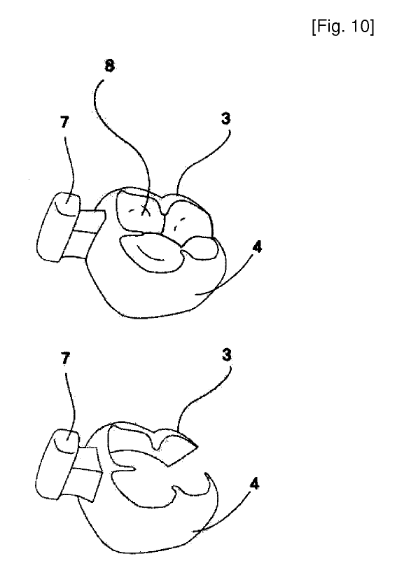

Meanwhile, as shown in FIG. 10, the holding parts 3 and 4 are manufactured in such a way that the pit, the non-functional cusp and the entire or a part of the occlusal surface, which is not in contact with the opposite tooth, are covered. Furthermore, the lingual holding part 3 mounted on the anterior tooth and the portion which requires the aesthetic sense covers the lingual side to the maximum within a range not causing any obstacle to occlusion, whereby the prosthesis can endure lateral pressure and vertical pressure.

Moreover, the male member 7 may be formed in one of T, I, L and O shapes and other various shapes in order to maximize holding force between the female member 6 and the male member 7. Shape of the female member 6 and the slot 6a is determined according to the shape of the male member 7.

Additionally, as shown in FIG. 5, in the case where there is any missing tooth at the right or left of the adjacent tooth, since the prosthesis can be manufactured in such a way that the male member 7 is formed at the right or left of the holding part, it can prosthetically treat the missing tooth in any cases with no grinding.

The male member 7 having the above structure serves to keep parallel between the missing adjacent teeth together with the holding part, so as to lead a smooth insertion of the artificial tooth 5 and reinforce compression resistance.

Therefore, the prosthesis according to the present invention can endure vertical pressure and horizontal pressure using elasticity of metal of the prosthesis used for tooth restoration, and the structure and gradient of the tooth to the maximum, and endure any external forces by surrounding the lingual pit and the buccal pit, the non-functional cusp, and the occlusal surface of the adjacent tooth, which are not in contact with the opposite tooth during occlusion.

Meanwhile, a method for manufacturing the dental prosthesis according to the present invention includes the steps of: duplicating an original model; waxing up the duplicated model; holding a sprue on the duplicated model in a state where the duplicated model is waxed up, and investing, burning out and casting the duplicated model.

In the case of the holding part and the female member manufactured by the above method, even though there is an under-cut, the lingual holding part can be formed from the lingual part at least to an area where the buccal part is started and the buccal holding part can be formed from the buccal part at least to an area where the lingual part is started. In the present invention, not only the separate type holding parts but also the integrated type holding parts can be attached to the lingual and buccal pits, the non-functional cusp and the occlusal surface, which is not in contact with the opposite tooth, of the missing adjacent tooth with no grinding of the tooth.

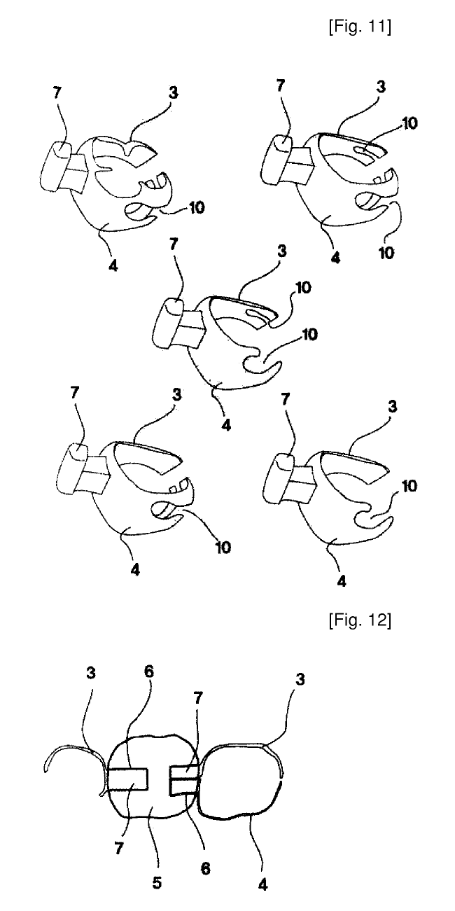

As shown in FIG. 11, the holding part has a groove 10 formed at the rear thereof in order to increase flexibility of the holding part, to cover the lingual and buccal pits, the non-functional cusp and the occlusal surface, which is not in contact with the opposite tooth, to the maximum, and to be easily mounted the holding part

As described above, the lingual holding part 3 and the buccal holding part 4 can be formed integrally with each other.

### MODE FOR THE INVENTION

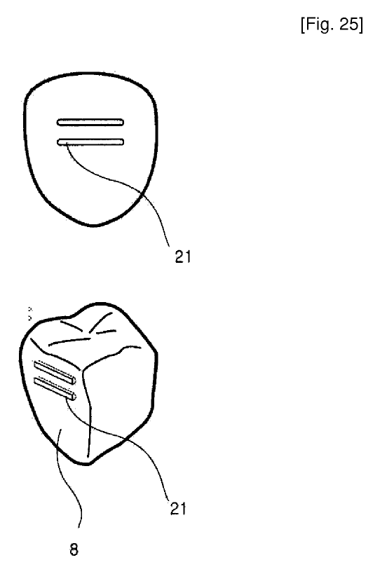

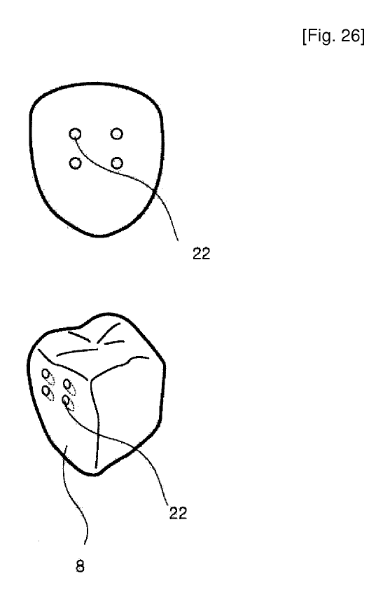

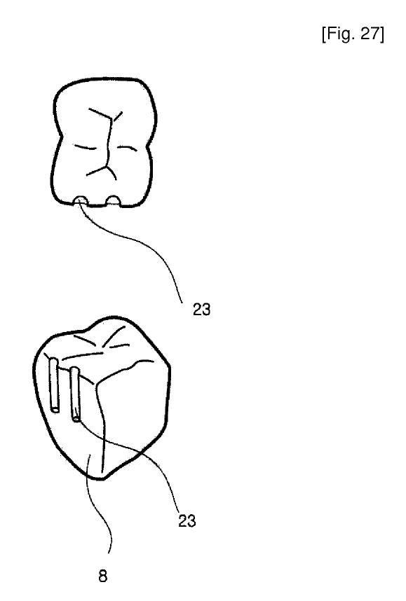

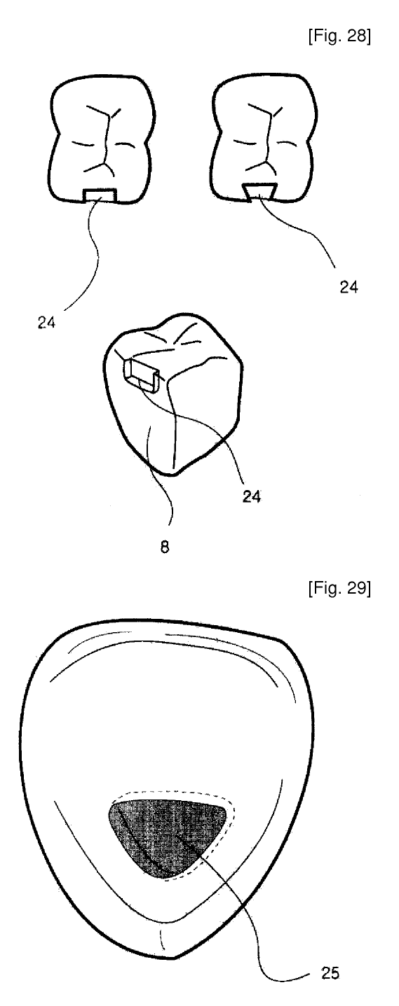

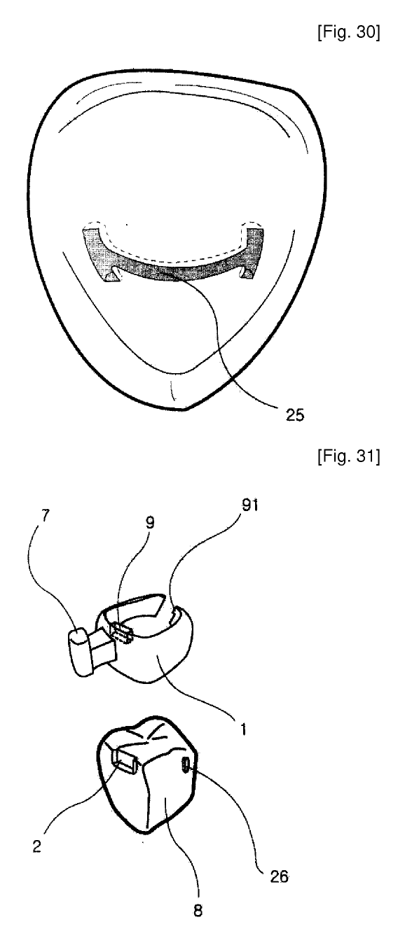

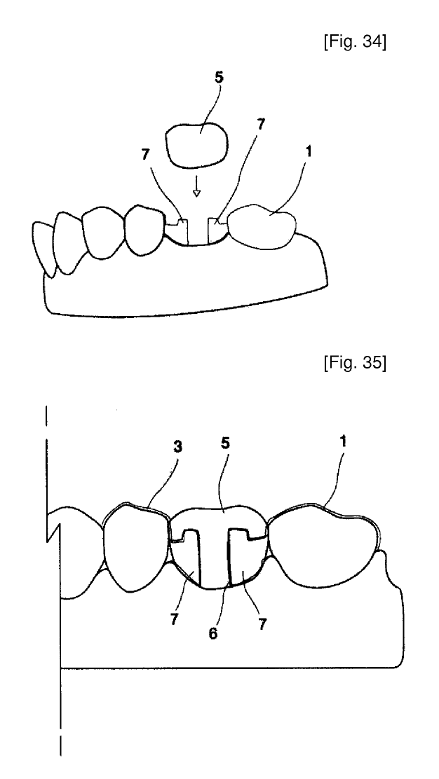

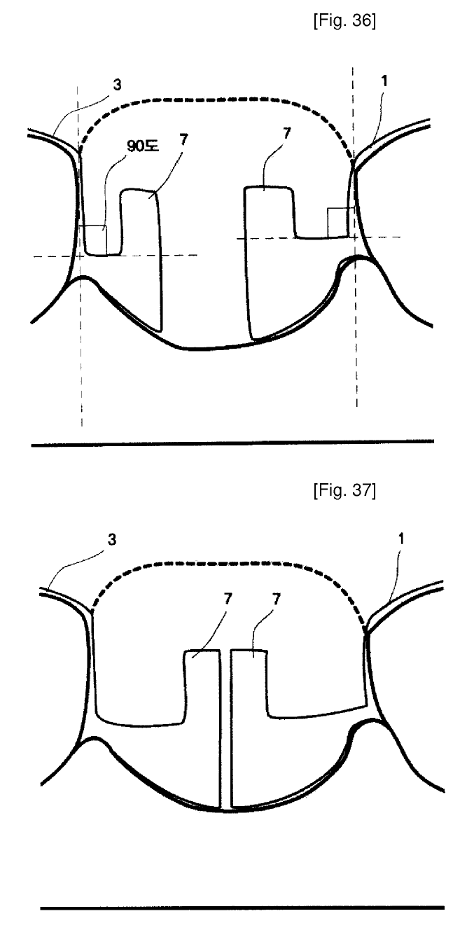

Hereinafter, referring to FIGS. 18 to 37, the integrated type holding part 1 will be described in detail.

The dental prosthesis according to the present invention includes the holding part 1, a projection 9 formed on the holding part 1, a male member 7 attached on the holding part 1, and a female member 6 formed on an artificial tooth 5.

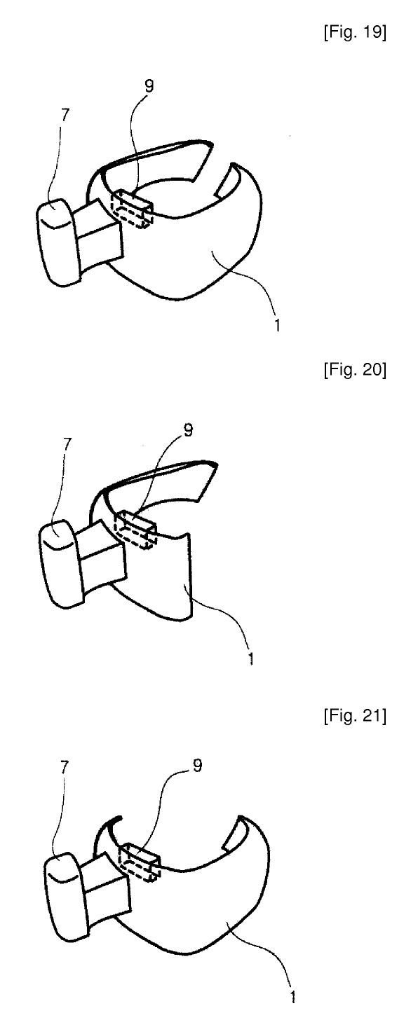

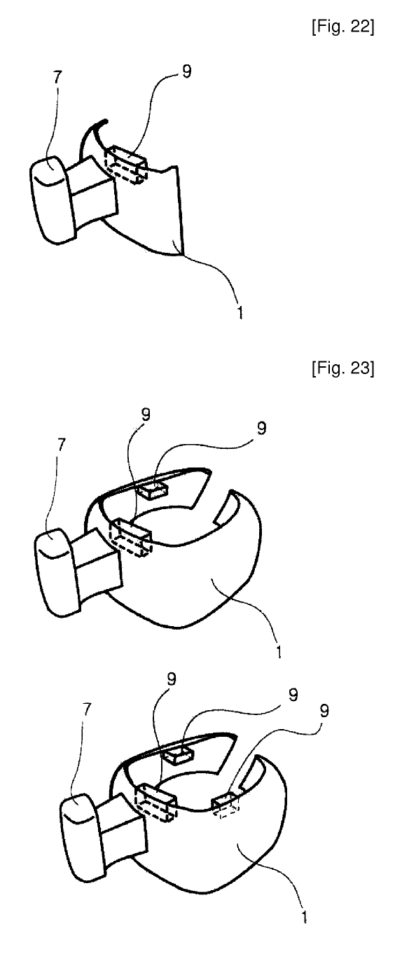

The holding part 1 may have one of various forms in consideration of holding force and an aesthetic sense, for example, a form that the holding part 1 is restricted only to a ground adjacent side (FIG. 22), a form that the holding part 1 extends from the ground adjacent side to the lingual side (FIG. 20), a form that the holding part 1 extends from the ground adjacent side to the buccal side (FIG. 21), or a form that the holding part 1 extends to the lingual side and the buccal side (FIG. 19). The ground form and size of the holding part 1 can be changed according to the size and position of the adjacent side of the lost adjacent tooth 8. Grinding is carried out within a range that a patient does not feel or sense abnormality without anesthesia. At this time, the holding part 1 has a depth of 0.5 mm˜2 mm. Grinding of the embedded type holding part 1 of the anterior tooth or a portion requiring the aesthetic sense is carried out at the lingual side and the adjacent side (including or not including the occlusal surface, but grinding of the holding part 1 of the premolar and the molar is restricted only to the adjacent side (including or not including the occlusal surface of the adjacent side), carried out only at the adjacent side and the lingual side (including or not including the occlusal surface of the lingual side) or the buccal side (including or not including the occlusal surface of the buccal side), or carried out at the adjacent side and the lingual and buccal sides (including or not including the occlusal surfaces of the lingual and buccal sides). The holding part 1 may have a projection 91 formed on a lingual or buccal end portion thereof. At this time, the adjacent tooth has an indented portion 26, which adopts any one of a hole type 23, a scratch type 21, a dot type 22, a rectangle type 24, a pin hole type, and other types according to the shape of the projection 91 of the holding part 1.

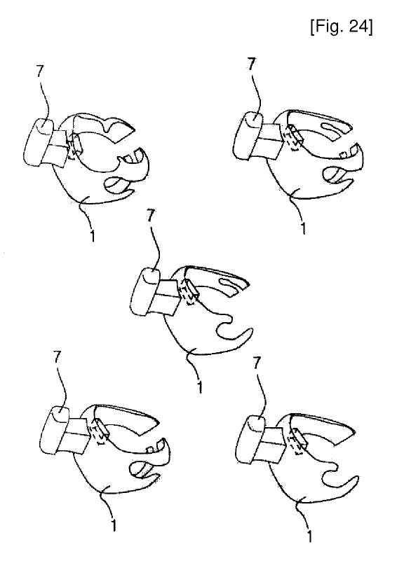

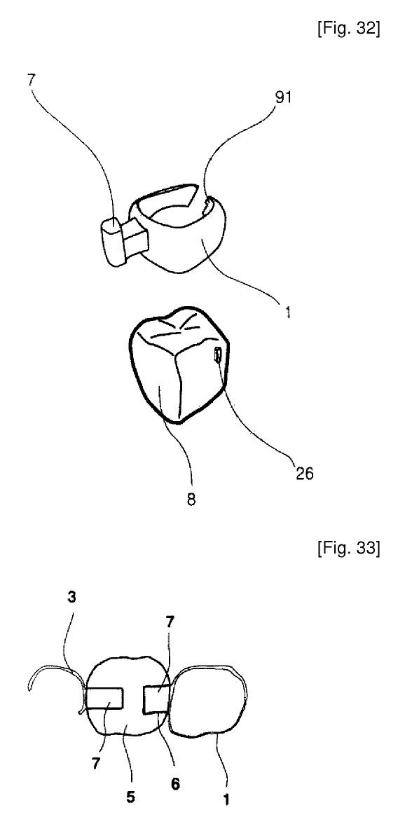

The ground portion has a predetermined angle in order to increase holding force of the holding part 1. The coverage of the holding part 1 is changed according to holding force of a necessary amount (FIG. 24). Alternatively, the projection 91 is formed on the lingual or buccal end portion of the holding part in a state where the adjacent side of the holding part is not ground (FIGS. 31 and 32), or formed on the adjacent tooth 8 where the adjacent side is ground and the lingual and buccal sides are ended in order to maximize holding force between the lingual and buccal holding parts and the adjacent tooth (FIGS. 31 and 32). To obtain a wide holding part including the ground surface and the adjacent ground portion which require much holding force, the original model is duplicated, the duplicated model is waxed up, and a sprue is held on the duplicated model without removing the waxed-up model from the duplicated model. After that, the duplicated model is invested, burned out and cast, and then mounted) to the original model. At this time, the coverage of the ground surface, the adjacent portion, the lingual side and the buccal side is adjustable according to the form and position of the tooth. An area where much holding force is not needed, namely, an area where there are no ground portion and undercut, is waxed up on the original model. After that, the sprue is held on the waxed-up model, and the waxed-up model is invested, burned out and cast, and then, seamed to the original model. Therefore, in the above case, the duplicated model is not needed. On an area where little holding force is required, the dental prosthesis can be manufactured in such a way that the holding part is applied only to the ground portion. On an area where an aesthetic sense is required, the holding part is positioned from the ground adjacent side only to the lingual side (FIG. 20) or only at the adjacent side (FIG. 22).

On an area where does not attach importance to the aesthetic sense, the holding part 1 extends to the lingual and buccal sides (FIG. 19). Moreover, the holding part 1 may cover the non-functional cusp and a portion of the occlusal surface where there is no obstacle in occlusion in order to obtain holding force to the maximum (FIG. 24). The male member 7 attached on the holding part 1 may take one of I, L, O and T forms and other modified forms in order to obtain the maximum coupling force between the male member 7 and the female member 6. Additionally, The male member 7 attached on the holding part 1 promotes a smooth insertion of the artificial tooth 5 by keeping parallel with the lost adjacent abutment and permits the dental prosthesis to endure occlusal force and lateral force by reinforcing compression resistance. The dental prosthesis according to the present invention does not cause degeneration of the dental pulp, exposure of the dental pulp, change of the opposite tooth, and hypersensitivity since it conserves the occlusal surface as it is with little grinding amount of the tooth when the lost tooth is restored.

The artificial tooth 5 may be made of ceramic or metal material. By the above method, the lost tooth can be restored with low cost within a short operation time period, differently from the prior art crown bridge prosthesis.

1. A dental prosthesis, which includes holding parts for fixing an adjacent tooth a male member formed integrally with the holding parts, a female member formed integrally with an artificial tooth and having a slot to insert the male member thereto to thereby recover or promote a function of a damaged tooth, wherein the holding parts cover a part or the whole of the adjacent tooth to surround the adjacent tooth the holding parts are modeled on the original surface pattern of the adjacent tooth to provide the same surface pattern as the adjacent tooth whereby the holding parts can be fixed to the adjacent tooth with no or little grinding of the adjacent tooth.

2. The dental prosthesis according to claim 1, wherein the male member is formed at both ends or only one end of the holding part.

3. The dental prosthesis according to claim 1, wherein the male member and the holding parts have a lingual side and a buccal side formed integrally.

4. The dental prosthesis according to claim 1, wherein the male member and the holding part are formed separately at the lingual side and the buccal side 4.

5. The dental prosthesis according to claim 1, wherein the holding part is formed only at the lingual side.

6. The dental prosthesis according to claim 1, wherein the dental prosthesis is S-shaped in such a way that on the anterior tooth and the front part of the artificial tooth, only the lingual holding part is located, and on the molar and the rear part of the artificial tooth, only the buccal holding part is located.

7. The dental prosthesis according to claim 1, wherein the holding part has a recess formed at the rear portion thereof in order to cover the lingual and buccal pits, non-functional cusp and a portion, which is not in contact with the opposite tooth, to the maximum, easily mount the holding part, and increase flexibility of the holding part.

8. (canceled)

9. (canceled)

10. The dental prosthesis according to claim 4, wherein the separate type holding part having the lingual holding part and the buccal holding part includes a pair of projection and groove formed at ends thereof and coupled with each other.

11. The dental prosthesis according to claim 1, wherein the holding part can cover the pit, non-functional cusp and a part or the whole of the occlusal surface with which the opposite tooth is not in contact.

12. A method for manufacturing a dental prosthesis comprising the steps of:
duplicating an original model;
waxing up the duplicated model;
holding a sprue on the duplicated model in a state where the duplicated model is waxed up; and
investing, burning out and casting the duplicated model.

13. The dental prosthesis according to claim 1, wherein an embedded type holding part is formed in such a way as to form a projection to the holding part and an indented portion corresponding to the projection is formed on the adjacent face of the adjacent tooth to thereby strengthen holding force of the holding part.

14. The dental prosthesis according to claim 13, wherein the embedded typeholding part is to increase holding force, and is mounted only on a ground adjacent side of the adjacent tooth, within a range from the ground adjacent side to the lingual side of the adjacent tooth, within a range from the ground adjacent side to the buccal side of the adjacent tooth, within a range from the ground adjacent side to the lingual side and the buccal side, or on the buccal side or the lingual side after grinding.

15. The dental prosthesis according to claim 13, wherein the embedded type holding part has projection formed in the rear portion thereof to secure holding force, and can increase the holding force only with the projection of the adjacent tooth even in a state where the adjacent side of the holding part is not ground.

16. The dental prosthesis according to claim 13, wherein the embedded type holding part additionally extends from the adjacent side, the buccal side and the lingual side to an occlusal surface of the adjacent tooth.

17. The dental prosthesis according to claim 2, wherein the holding part can cover the pit, non-functional cusp and a part or the whole of the occlusal surface with which the opposite tooth is not in contact.

18. The dental prosthesis according to claim 3, wherein the holding part can cover the pit, non-functional cusp and a part or the whole of the occlusal surface with which the opposite tooth is not in contact.

19. The dental prosthesis according to claim 4, wherein the holding part can cover the pit, non-functional cusp and a part or the whole of the occlusal surface with which the opposite tooth is not in contact.

20. The dental prosthesis according to claim 5, wherein the holding part can cover the pit, non-functional cusp and a part or the whole of the occlusal surface with which the opposite tooth is not in contact.

21. The dental prosthesis according to claim 6, wherein the holding part can cover the pit, non-functional cusp and a part or the whole of the occlusal surface with which the opposite tooth is not in contact.

22. The dental prosthesis according to claim 7, wherein the holding part can cover the pit, non-functional cusp and a part or the whole of the occlusal surface with which the opposite tooth is not in contact.

23. The dental prosthesis according to claim 10, wherein the holding part can cover the pit, non-functional cusp and a part or the whole of the occlusal surface with which the opposite tooth is not in contact.
